(19) United States
(12) Patent Application Publication
(10) Pub. No.: US 2005/0008860 A1
(43) Pub. Date: Jan. 13, 2005

(54) Selective method for detection, identification and assay of a divalent metal ion in a sample

(76) Inventor: Francis Garnier, Champigny Sur Marne (FR)

Correspondence Address: OLIFF & BERRIDGE, PLC, P.O. BOX 19928, ALEXANDRIA, VA, 22320, US

(21) Appl. No.: 10/496,338

(22) PCT Filed: Dec. 2, 2002
(86) PCT No.: PCT/FR02/04135

(30) Foreign Application Priority Data
Nov. 30, 2001 (FR) 01/15669

(51) Int. Cl. B32B 5/16; H01M 4/00

(52) U.S. Cl. 428/403; 428/407; 429/128; 429/137

(57) ABSTRACT

The invention concerns a method for detection, identification and assay of a potentially toxic metal ion in a sample suspected of containing a plurality of metal ions. The invention is characterized in that it consists in using a probe characterized in that it comprises an electroactive homopolymer or copolymer polymer of at least two monomers, functionalized by a chelating agent, and in quantifying a potential difference characteristic of the redox potential of the cation(s) present in the sample.

The invention relates to organic electrodes prepared from electroactive polymers functionalized by agents capable of interacting with chemical entities and of thus making possible their detection, assay and identification by the measurement of the perceptible and selective variations in the electrochemical properties of the electroactive polymer.

The abovementioned variations are of potentiometric type, such as a variation in the oxidation potential of the electroactive polymer before and after interaction, or of amperometric type, such as a variation in the oxidation or reduction current of the polymer before and after interaction, determined at a predetermined potential.

Conjugated polymers, such as polypyrroles, polythiophenes, polyanilines, polyphenylenes and their derivatives, are known for their electroactive nature and authors have been interested in the use of these polymers by functionalizing them in order to develop analyte sensors.

For example, EP-B-0 314 009 teaches thienylpyrroles grafted in the 3-position of the pyrrole ring capable of covalently bonding to an organic molecule, but these products, because of their hydrophobicity, are not suitable for detection in an aqueous medium.

WO-A-95/29199 teaches a polypyrrole composed of monomers each consisting of a pyrrole ring covalently substituted on the carbon in the 3-position of the pyrrole ring by a polynucleotide probe. The polypyrrole thus obtained is applied to the detection, and optionally assay, of ligands, in vitro or in vivo.

The ability of chelating agents, such as NTA (nitrilotriacetate) or IDA (iminodiacetate), to bind metals has already been studied with di- or trivalent metals. For example, immobilized metal affinity chromatography (IMAC) has been used to purify proteins (Poruth et al., Nature, 258, 598-599 (1975)) using IDA as chelating agent. The IDA was charged with metal ions, such as Zn²⁺, Cu²⁺ or Ni²⁺, and was used to purify proteins or peptides.

Patent Application WO 90/02829 discloses microelectrodes coated with electropolymers, such as, in particular, a film of electroactive polymer in which EDTA is incorporated. A disadvantage of this electropolymer is a problem of resistance during subsequent binding to any analyte.

The Applicant Company has found, surprisingly, that the detection of potentially toxic metal ions in a sample capable of comprising them was greatly improved by the use of an electroactive probe composed of an electroactive polymer to which a chelating agent is covalently bonded.

Thus, a first subject matter of the invention is an electroactive probe, characterized in that it comprises an electroactive polymer which is a homopolymer or copolymer of at least two monomers and which is functionalized by a chelating agent.

The electroactive polymer which is suitable for the purposes of the invention is a polymer which is electroactive in water.

According to one embodiment of the invention, the electroactive polymer is chosen from polypyrrole, polyacetylene, polyazine, poly(p-phenylene), poly(p-phenylene vinylene), polypyrene, polythiophene, polyethylenedioxythiophene, polyfuran, polyselenophene, polypyridazine, polycarbazole and polyaniline.

The chelating agent used in the probe of the invention is any chelating agent which is nonspecific, that is to say capable of multiple detection.

According to one embodiment of the invention, the chelating agent is chosen from iminodiacetic acid, nitrilotriacetic acid and ethylenediaminetetraacetic acid.

IDA has three sites available for the chelation of metals. NTA is a tetradentate agent which binds metal ions in a more stable way than other resins available for chelation.

EDTA is a hexadentate complexing agent in its ionic form.

The probe of the invention as defined above exhibits a structure such that the electroactive polymer of the invention is functionalized by a chelating agent. In other words, the structure is such that the chelating agent is bonded directly to the conducting polymer in a covalent fashion via a connecting group.

A connecting group according to the invention connects two chemical entities via a covalent bond, at least one of the chemical entities having been activated or activatable beforehand, for the purpose of this interaction, by an activated or activatable group. The connecting group can thus result from the reaction of a said activated or activatable group of one entity with a reactive functional group of the other entity, and vice versa, or from the reaction of a said activated or activatable group of one entity with another said activated or activatable group of the other entity.

The term “activated group” is understood to mean a group which makes possible, through its agency, the interaction of the entity to which it is attached with another entity. By way of example, it may be an activated ester group, such as the —CO—[O—N-phthalimide] group. The term “activatable group” is understood to mean a group which can be converted to an activated group, for example under certain reaction conditions or when brought into contact with an activated group capable of interacting with it, such as the —CH₂—COOH or —CH₂—CH₂—OH group.

The invention also relates to the electroactive polymer which is a homopolymer or copolymer, characterized in that it comprises at least two monomers functionalized by a chelating agent.

The electroactive polymer of the invention advantageously corresponds to the following characteristics, considered alone or in combination:
the monomers are chosen from pyrrole, acetylene, azine, p-phenylene, p-phenylene vinylene, pyrene, thiophene, polyethylenedioxythiophene, furan, selenophene, pyridazine, carbazole and aniline, and
the chelating agent is chosen from iminodiacetic acid, nitrilotriacetic acid and ethylenediaminetetraacetic acid.

According to a preferred embodiment of the invention, the electroactive polymer of the invention, as such or in the electroactive probe, is a polypyrrole composed of at least two monomers and the chelate is an IDA or an NTA, said chelate being attached via a covalent bond in the 3-position of the pyrrole ring through the agency of a carboxymethyl residue.

The invention also relates to a process for the preparation of a conducting polymer functionalized by a chelating agent.

This process comprises the following stages:
a) synthesis, by conventional esterification methods, of the monomers substituted by an activated group,
b) polymerization and deposition by coulometry in the form of films on electrodes,
c) functionalization by the chelating agent by hydrolysis of the activated group.

The conducting polymer can be functionalized by a chelating agent via two routes, the first by the functionalization of the monomer followed by the polymerization and the second by functionalization after formation of the polymer film.

The monomers substituted by an activated group are synthesized by conventional esterification methods, for example for the esterification of a carboxylic acid, such as 3-pyrroleacetic acid, by N-hydroxyphthalimide.

The monomers obtained are subsequently polymerized and deposited by coulometry in the form of films on electrodes, and the functionalization by the chelating agent is carried out subsequently by hydrolysis of the activated group.

The probes of the invention are of use in the detection of potentially toxic metal ions and in particular of divalent metal cations. Examples of metals which give cations capable of forming the subject of such detection are, for example, cadmium, zinc, copper, nickel, mercury, lead, chromium, cobalt and silver, which, according to their oxidation numbers, can give rise to, for example, divalent, monovalent, trivalent or tetravalent cations.

Thus, the invention also relates to a selective method for detection, identification and assay of a potentially toxic metal ion in a sample capable of comprising a plurality of metal ions, characterized in that use is made of a probe according to the invention and in that a difference in potential characteristic of the redox potential of the cation or cations present in the sample is observed and/or measured.

This difference in potential or this variation in current is observed and/or measured before complexing and after complexing, that is to say between the functionalized electroactive polymer without metal complex formed and the same polymer after chelation with a metal cation.

Finally, a subject matter of the present invention is an electrode, all or part of the surface of which for contact with the electrolyte is coated with a probe as defined above. Such an electrode can be obtained by any conventional technique well known to a person skilled in the art. Thus, such a preparation can be carried out by deposition of the functionalized polymer at the surface of a conventional electrode. By way of example, conducting polymers can be deposited by coulometry by controlling the current charge at the surface of an electrode made of platinum, of gold or of any other metal or alloy well known in these techniques.

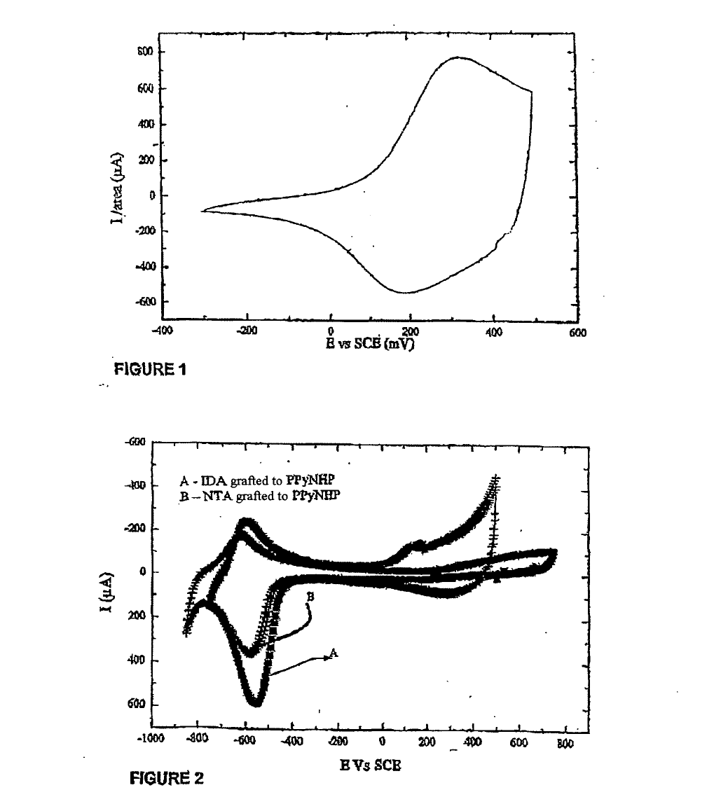

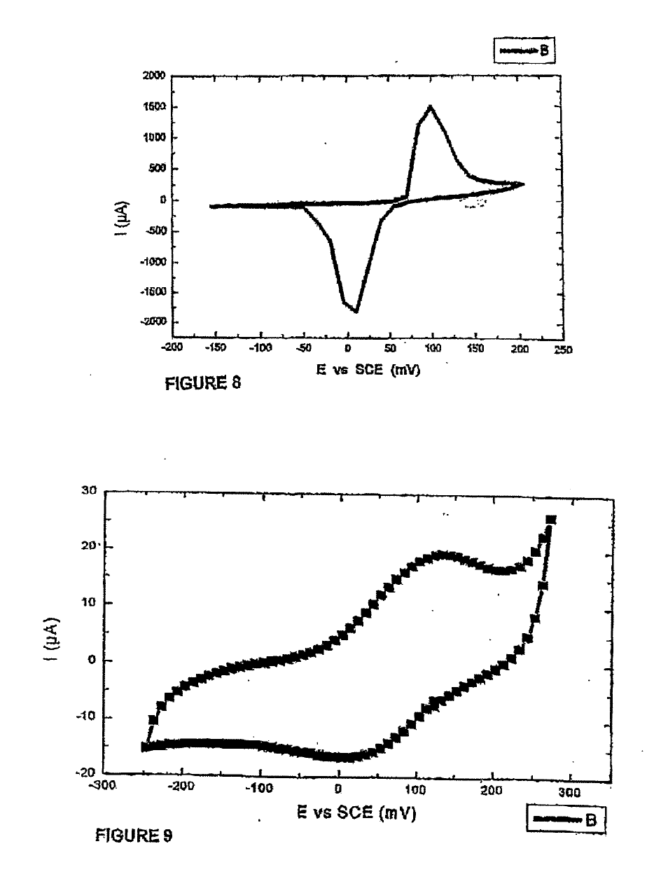

The various subject matters of the invention are illustrated in the preparation and implementational examples 1 to 10 and in FIGS. 1 to 10, which are commented upon in the following examples.

### EXAMPLE 1

### Preparation of Films Based on Electrically Conducting Polymers

Pyrrole monomers functionalized in the 3-position by an N-hydroxyphthalimide (NHP) were synthesized and subsequently polymerized to produce a film of poly(3-(carboxymethylpyrrole)NHP) polymer carrying active ester groups.

### Synthesis of the Monomer

The 3-carboxymethylpyrrole-NHP monomer was synthesized by esterifying the carboxyl group of 3-pyrroleacetic acid with N-hydroxyphthalimide and dicyclocarboxydiimide, as catalyst, in chloroform, as solvent, at ambient temperature. The reaction scheme is presented below.

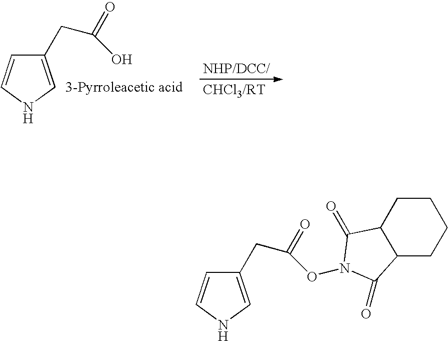

### 3-pyrroleacetic acid, CHCl₃/RT

### Synthesis of the Polymer

A 0.1M solution of 3-carboxymethylpyrrole-NHP monomer is prepared in freshly distilled anhydrous acetonitrile in the presence of an electrolyte (LiClO₄, 0.5M). This monomer is polymerized in a four-compartment cell using a 0.7 cm² platinum electrode, an auxiliary platinum electrode and a saturated calomel electrode as reference electrode, at the controlled potential of 0.9 V, to produce the poly(3-carboxymethylpyrrole-NHP) film. The film obtained is washed with acetone and dried. The electroactivity is subsequently measured in an acetonitrile medium comprising 0.1M LiClO₄ as electrolyte after purging with argon to remove oxygen. Cyclic voltametry is recorded at the rate of 20 mV/s. A stable and reversible electrochemical signal with an oxidation peak Eox=317 mV/SCE and confirmation of the electrochemical activity in an organic medium are obtained. After analysis, the electrode is washed with acetone and dried.

### EXAMPLE 2

### Grafting of Iminodiacetic Acid (IDA) or of N-(5-amino-1-carboxypentyl)iminodiacetic acid (NTA) to Conducting 3-carboxymethylpyrrole Polymer Films

Once the poly(3-carboxymethylpyrrole-NHP) film has been formed and analyzed as described in example 1, the electrode is immersed in a saturated aqueous solution of NTA or IDA at ambient temperature for 12 hours, washed with ultrapure water and dried. The synthesis of poly(3-carboxymethylpyrrole-IDA) or of poly(3-carboxymethylpyrrole-NTA) is represented below:

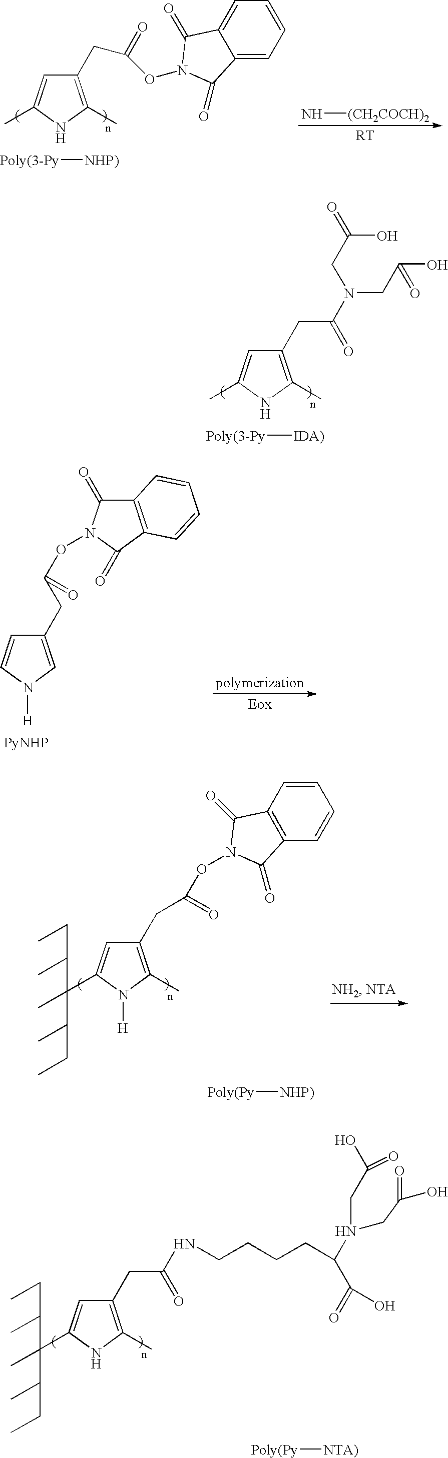

The electrode obtained is washed with ultrapure water and dried, and the electroactivity is monitored, in an aqueous medium comprising 0.5M NaCl. The electrochemical analysis is represented in FIG. 2.

The electrochemical signal is stable and reversible in an aqueous medium.

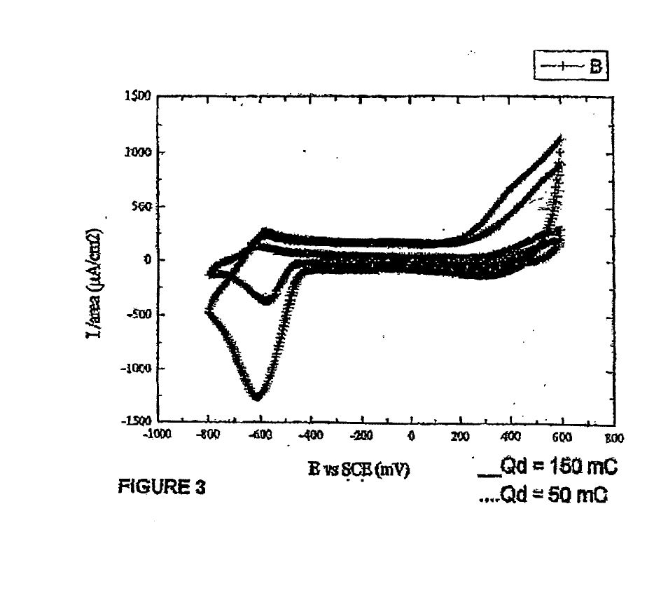

Poly(3-carboxymethylpyrrole-NHP) films with different thicknesses were prepared and the films obtained were grafted with NTA. The electrochemical response recorded in aqueous medium in the presence of 0.5M NaCl confirms the presence of an electrochemically active film in aqueous medium. Comparison of the charge of poly(3-carboxymethylpyrrole-NHP) deposited at the beginning on the electrode and the calculated charge of NTA grafted to the film suggests that the efficiency for grafting NTA or IDA to the film 100%. In other words, the amount of NTA or of IDA grafted to the poly(3-carboxy)pyrrole film depends on the amount of 3-carboxymethylpyrrole-NHP units present on the electrodes, as illustrated by the curves in FIG. 3.

### EXAMPLE 3

### Detection of Metals by Modified Conducting Polymer Films

Complexing of the poly(3-carboxymethylpyrrole-NTA) film with copper on an electrode.

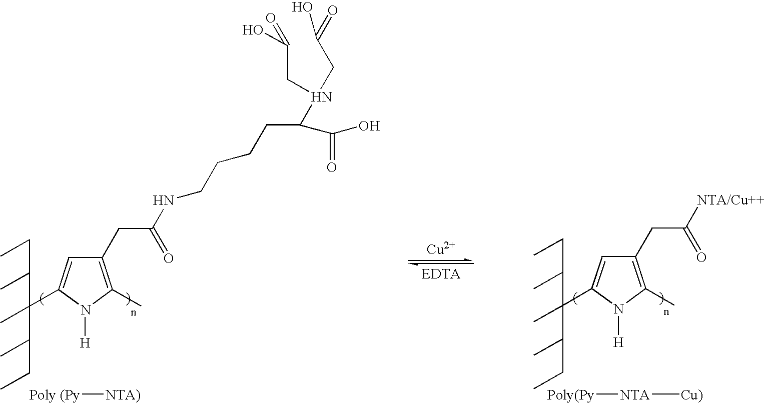

The electrode comprising the poly(3-carboxymethylpyrrole-NTA) film was analyzed electro-chemically in an aqueous medium, washed with deionized water and dried, and it is subsequently immersed in an aqueous solution of CuCl₂ in the presence of 0.5M NaCl at ambient temperature for 3 hours.

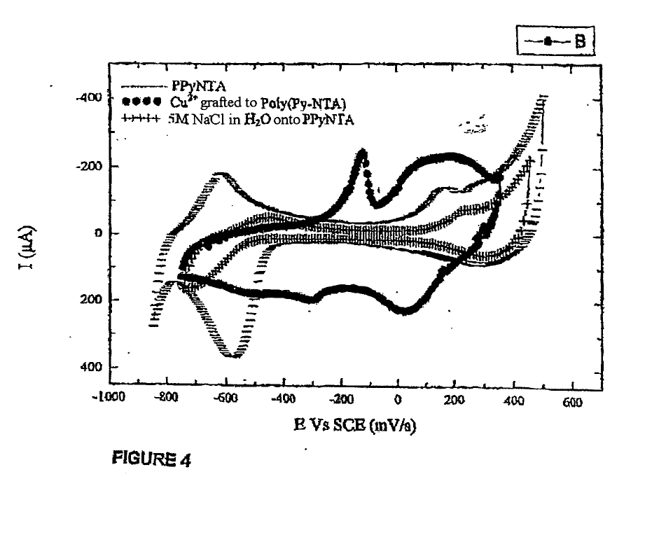

The electrode is subsequently rinsed in deionized water, dried and analyzed electrochemically in an aqueous solution comprising 0.5M NaCl. The disappearance of the electrochemical signal of poly(3-carboxymethylpyrrole-NTA) and the appearance of a peak characteristic of the oxidation of Cu⁺ to Cu²⁺ at −0.2V-0.35V, which is stable but nonreversible and electroactive in aqueous medium, confirms the complexing of the copper with the poly(3-carboxymethylpyrrole-NTA) (FIG. 4).

To study the effects of 0.5M NaCl and water on the poly(3-carboxymethylpyrrole-NTA) film as reference film, another electrode was prepared from poly(3-carboxymethylpyrrole-NHP), having the same amount of charge deposited, and then this poly(3-carboxymethylpyrrole-NHP) film was modified with NTA as described above. The electrode obtained was subsequently again immersed in an aqueous solution comprising 0.5M NaCl at ambient temperature for 3 hours. The electrochemical analyses of these electrodes are represented in FIG. 4.

Analysis of the voltametric cycle indicates that the poly(3-carboxymethylpyrrole-NTA) film loses its electroactivity in an aqueous medium by treatment with 0.5M NaCl during the same time interval because of the hydrophobic nature of the film, whereas, on complexing the copper, the signal of the poly(3-carboxymethylpyrrole-NTA) is not only modified but also its electroactivity is increased in an aqueous medium, the signal remaining electrochemically stable and reversible.

### EXAMPLE 4

### Effect of the Thickness of the Conducting Polymer Film on the Electrochemical Response of the Copper

The poly(3-carboxymethylpyrrole-NHP) monomer is deposited by polymerization on two electrodes with two different amounts of charges (Q=50 mC and 150 mC). It is subsequently electrochemically as described above and the electrodes are immersed in an aqueous solution comprising NTA. The electrodes are subsequently immersed in an aqueous solution having the same concentration of CuCl₂ and 0.5M NaCl for 3 hours at ambient temperature, and then washed with deionized water, dried and analyzed in an aqueous medium comprising 0.5M NaCl.

The amount of the copper complexed with the poly(3-carboxymethylpyrrole-NTA) film depends on the amount of NTA on the polymer film, which depends on the amount of functionalized units of pyrrole monomers which were polymerized on the platinum electrode. In other words, this means that the amount of copper complexes on the polymer films depends on the thickness of the polymer films. This is represented in FIG. 5, in which it is observed that two electrodes with different thicknesses complex different amounts of copper.

### EXAMPLE 5

### Effect of the Concentration of Copper on the Electrochemical Response of the Polymer Films

This effect is studied on four identical electrodes comprising poly(3-carboxymethylpyrrole-NHP) polymer films composed of the same amount of monomers and grafted with the same amounts of NTA. Three identical electrodes were immersed in an aqueous solution of CuCl₂ comprising 0.5M NaCl at different concentrations, respectively 2×10⁻³ m/l, 2×10⁻⁶ m/l and 2×10⁻⁷ m/l, of copper and the fourth electrode was immersed in an aqueous solution comprising 0.5M NaCl and no copper, as reference electrode, for four hours at ambient temperature. The electrodes were washed several times with water, dried and subsequently analyzed in an aqueous medium comprising 0.5M NaCl.

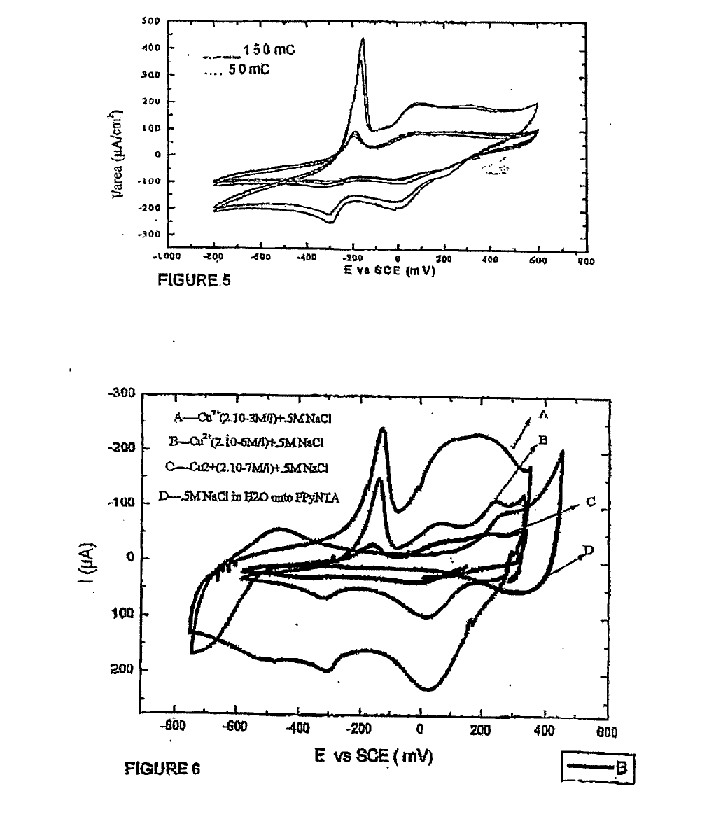

The results are represented in FIG. 6, which shows the effect of the concentration of Cu²⁺ on the electrochemical response of Cu²⁺.

The effect of the concentration of copper on the electrochemical response of the polymer films is summarized in table 1 below.

TABLE 1

| E (mV) | Cu²⁺ (m/l) | I (μA) | I − I_{ref} = ΔI | ΔC |
|---|---|---|---|---|
| 160.2 | 0 | 15.81 | 0 | 0 |
| 160.2 | 2 × 10⁻⁷ | 32.28 | 16.47 | 2 × 10⁻⁷ |
| 158.6 | 2 × 10⁻⁶ | 145.7 | 129.89 | 2 × 10⁻⁶ |
| 158.6 | 2 × 10⁻³ | 248.1 | 232.29 | 2 × 10⁻³ |

ΔI = variation in the current
ΔC = variation in the concentration of copper

The analysis of these voltammograms shows that the sensitivity of the intensity of the current of the signal is in relation to the complexing of the copper to the poly(3-carboxymethylpyrrole-NTA) films. The minimum current intensity signal can be read for a concentration of copper of down to 2×10⁻⁷ m/l in water by poly(3-carboxymethylpyrrole-NTA) film.

FIG. 6 shows that the electrochemical signal is stable and reversible.

### EXAMPLE 6

### Electrochemical Reversibility of the Electrodes

The scheme below shows the complexing and the decomplexing of copper and of mercury with the poly(3-carboxymethylpyrrole-NTA) film on the electrode.

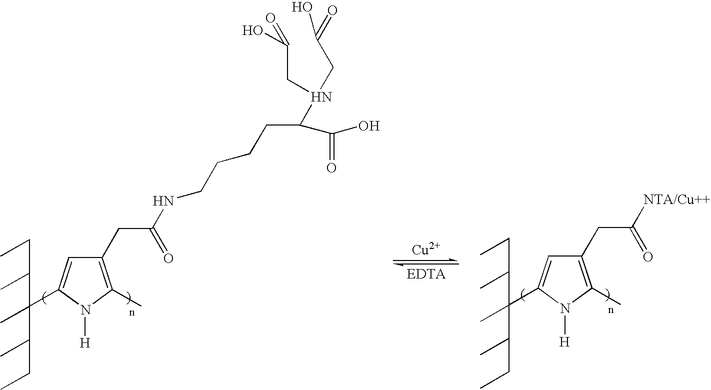

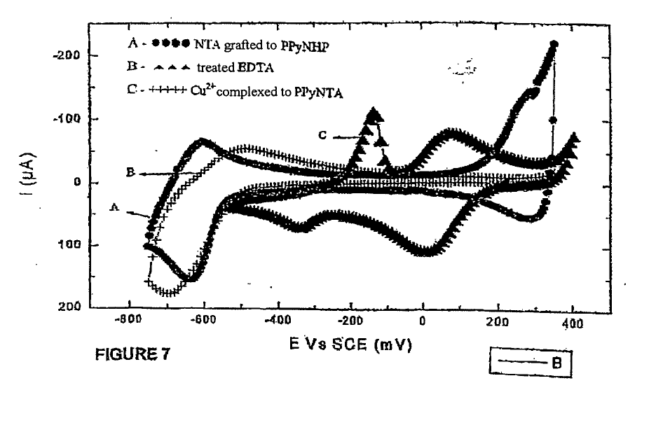

To confirm the presence of Cu²⁺ on the poly(3-carboxymethylpyrrole-NTA) polymer film and to check whether it is possible or not to replace the poly(3-carboxymethylpyrrole-NTA) film by a poly(3-carboxymethyl-pyrrole-EDTA) film, the electrodes comprising the poly(3-carboxymethylpyrrole-NTA) polymer film complexed with Cu²⁺ were immersed in a 0.1M EDTA (ethylenediaminetetraacetic acid) solution for 15 minutes. The electrodes are subsequently rinsed with water, dried and analyzed. Analysis of the initial voltammograms of the poly(3-carboxymethylpyrrole-NTA) shows that the electrochemical signal is reversible and stable. On repeating the same series of recomplexing the poly(3-carboxymethylpyrrole-NTA) polymer film with Cu²⁺, the presence of Cu²⁺ is again observed. This confirms the complexing of the divalent metal Cu²⁺ to the poly(3-carboxymethylpyrrole-NTA) film, as shown in FIG. 7. Analysis of FIG. 7 confirms the formation of complexes of poly(3-carboxymethylpyrrole-NTA) with copper and shows that copper is not deposited on the film. The complexing and the decomplexing of copper to the poly(3-carboxymethylpyrrole-NTA) film is reversible and stable in the system.

The same observation was made in the case of the complexing of poly(pyrrole-NTA) with mercury and decomplexing with EDTA.

### EXAMPLE 7

### Complexing of Mercury with the poly(3-carboxymethylpyrrole-NTA) Film on the Electrode

The complexing of mercury with the poly(3-carboxymethylpyrrole-NTA) film is represented in the scheme below.

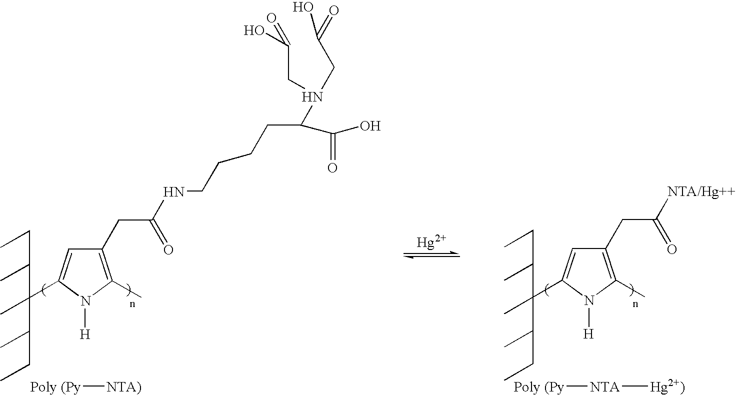

After analysis in an aqueous medium, the poly(3-carboxymethylpyrrole-NTA) film was washed with deionized water and dried, and the electrode was immersed in a saturated aqueous solution (deionized water) of HgCl₂ comprising 0.5M NaCl at ambient temperature for 3 hours.

The electrode was subsequently analyzed in an aqueous solution which comprises 0.5M NaCl. The disappearance of the electrochemical signal of poly(3-carboxymethylpyrrole-NTA) and the appearance of a peak characteristic of the oxidation of Hg⁺ into Hg²⁺ at −0.1V and +0.02V, which is stable, reversible and electroactive in an aqueous medium, confirms the complexing of the mercury with the poly(3-carboxymethylpyrrole-NTA). To study the effect of 0.5M NaCl and water on the poly(3-carboxymethylpyrrole-NTA) film, another poly(3-carboxymethylpyrrole-NHP) electrode having the same amount of charge deposited on the film, modified by NTA, was immersed in the aqueous solution comprising solely 0.5M NaCl, rinsed with water, dried and analyzed electrochemically. The results are presented in FIG. 9 and show the formation of complexes of poly(3-carboxymethylpyrrole-NTA) with mercury by the modification of the electrochemical signal, which is reversible and stable in an aqueous medium.

### EXAMPLE 8

### Effect of the Concentration of Mercury on the Electrochemical Response of the Polymer Films

To study the effect of concentration of the mercury on the poly(3-carboxymethylpyrrole-NTA) polymer films and the electrochemical modifications, four identical electrodes comprising poly(3-carboxymethylpyrrole-NHP) polymer films having the same amount of monomers and grafted with the same amount of NTA were studied electrochemically. Three electrodes are immersed in a 0.5M aqueous HgCl₂ solution at different concentrations of mercury, respectively 2×10⁻³ m/l, 2×10⁻⁶ m/l and 2×10⁻⁷ m/l of mercury, comprising NaCl and the fourth electrode was immersed in an aqueous solution comprising only 0.5M NaCl. The treatment was carried out for three hours at ambient temperature. The electrodes are subsequently washed several times with water, dried and subsequently analyzed in an aqueous solution comprising 0.5M NaCl.

The results are presented in table 2 below, which summarizes the influence of the mercury concentration.

TABLE 2

| E (mV) | Hg²⁺ (m/l) | I (μA) | I − I_{ref} = ΔI | ΔC |
|---|---|---|---|---|
| 125.6 | 0 | 06.68 | 0 | 0 |
| 125.2 | 2 × 10⁻⁷ | 19.31 | 12.63 | 2 × 10⁻⁷ |
| 126.2 | 2 × 10⁻⁶ | 52.07 | 45.39 | 2 × 10⁻⁶ |
| 126.7 | 2 × 10⁻³ | 91.59 | 84.91 | 2 × 10⁻³ |

ΔI = variation in the current
ΔC = variation in the concentration of mercury Hg²⁺

Analysis of the voltammograms shows that the sensitivity of the intensity of the current of the signal is in relation to the concentration of the mercury complexed to the poly(3-carboxymethylpyrrole-NTA) films. The minimum current intensity of the signal which can be read corresponds to the concentration of mercury 2×10⁻⁷ m/l in water by poly(3-carboxymethylpyrrole-NTA) film.

### EXAMPLE 9

### Selectivity of the Electrodes

Copper is characterized by redox potentials for the Cu^{II}/Cu^{I} and Cu^{I}/Cu⁰ transitions.

The metals each have their specific oxidation potential. The oxidation potentials given in the literature for various metals are summarized in table 3 below.

TABLE 3

| Metal | Eₒₓ (V)/SCE |
|---|---|
| Fe³⁺/Fe²⁺ | 0.5018 |
| Cu²⁺/Cu⁺ | −0.1102 |
| Cu²⁺/Cu⁺ | 0.072 |
| Co²⁺/Co⁺ | 0.0118 |
| Mn²⁺/Mn | −1.2972 |
| Ni²⁺/Ni | −0.4982 |
| Zn²⁺/Zn | −1.031 |
| Hg²⁺/Hg | 0.100 |

Thus, in order to electrochemically detect these metals, it is possible to do it by comparing the standard potential value with that of the oxidation peak observed during the electrochemical analysis of the electrode, after complexing with a metal cation. For example, for copper, the characteristic oxidation peak for Cu²⁺/Cu⁺ is −0.1 V/SCE, whereas for mercury, for Hg²⁺/Hg⁺, it is 0.1 V/SCE by electrode of poly(3-carboxymethylpyrrole-NTA) film.

This confirms that these electrodes can be selective for the detection of Cu²⁺ or Hg²⁺.

### EXAMPLE 10

### Detection Limit for Copper and Mercury for an Electrode Modified by Conducting Polymers Functionalized by Chelates

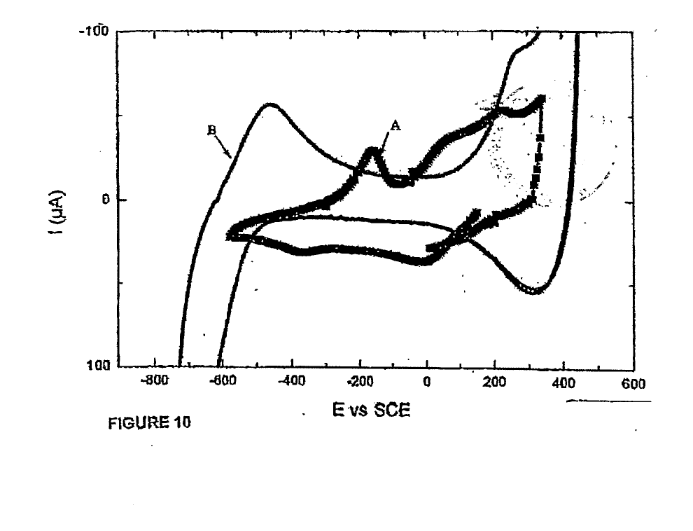

In order to determine the detection limit for copper and mercury, an electrochemical analysis of a solution comprising the minimum amounts of copper and of mercury detectable by the poly(3-carboxymethylpyrrole-NTA) electrodes was carried out. The electrochemical response for the poly(3-carboxymethylpyrrole-NTA) film complexed with copper at a concentration of copper of 2×10⁻⁷ m/l and the comparison with a reference voltammogram of a poly(3-carboxymethylpyrrole-NTA) electrode without complexing with copper, which demonstrates only the effect of 0.5M NaCl in water on the polymer film, are demonstrated in FIG. 10.

The effect of the concentration in divalent metals on the electrochemical response has made it possible to show that the sensitivity of these electrodes is of the order of 2 μA/2×10⁻⁷ m/l of Cu²⁺ in solution, which corresponds to 3×10⁻⁸ μA/ml for Cu²⁺ in the aqueous solution. In other words, the detection limit for Cu²⁺ is 4 ppb in aqueous solution.

For mercury, the sensitivity of the electrodes is of the order of 0.3 μA/2×10⁻⁷ m/l in solution, which corresponds to 1×10⁻⁸ μA/ml of Hg²⁺ in the aqueous solution. The detection limit for Hg²⁺ is of the order of 4 ppb in aqueous solution.

1-12. (Canceled)

13. A selective process for detection, identification and assay of a potentially toxic metal ion in a sample capable of comprising a plurality of metal ions, characterized in that use is made of an electroactive probe comprising at least one electroactive polymer which is a homopolymer or copolymer of at least two monomers functionalized by a chelating agent, said chelating agent being covalently bonded to said polymer, and in that a difference in potential characteristic of the redox potential of the cation or cations present in the sample is quantified.

14. The process as claimed in claim 13, characterized in that the detection and/or the assay of said metal ion is carried out by observation and/or measurement of a difference in potential or of a variation in the current between the functionalized electroactive polymer without metal complex formed and the same polymer after chelation with a metal cation.

15. The process as claimed in claim 13, characterized in that the electroactive polymer is chosen from polypyrrole, polyacetylene, polyazine, poly(p-phenylene), poly(p-phenylene vinylene), polypyrene, polythiophene, polyethylenedioxythiophene, polyfuran, polyselenophene, polypyridazine, polycarbazole and polyaniline.

16. The process as claimed in claim 13, characterized in that the chelating agent is chosen from iminodiacetic acid, nitrilotriacetic acid and ethylenediaminetetraacetic acid.

17. The process as claimed in claim 13, characterized in that the electroactive polymer is a polypyrrole and the chelate is iminodiacetic acid (IDA) or nitrilotriacetic acid (NTA), said chelate being attached via a covalent bond in the 3-position of the pyrrole ring through the agency of a carboxymethyl residue.

18. An electroactive probe, characterized in that it comprises at least one electroactive polymer which is a homopolymer or copolymer of at least two monomers functionalized by a chelating agent, said chelating agent being covalently bonded to said polymer and being chosen from nitrilotriacetic acid and ethylenediaminetetraacetic acid.

19. The electroactive probe as claimed in claim 18, characterized in that the electroactive polymer is chosen from polypyrrole, polyacetylene, polyazine, poly(p-phenylene), poly(p-phenylene vinylene), polypyrene, polythiophene, polyethylenedioxythiophene, polyfuran, polyselenophene, polypyridazine, polycarbazole and polyaniline.

20. The electroactive probe as claimed in claim 18, characterized in that the electroactive polymer is a polypyrrole and the chelate is nitrilotriacetic acid, said chelate being attached via a covalent bond in the 3-position of the pyrrole ring through the agency of a carboxymethyl residue.

21. An electrode, all or part of the surface of which is coated with a probe as defined in claim 18.

22. An electroactive polymer which is a homopolymer or copolymer, characterized in that it comprises at least two monomers functionalized by a chelating agent, said chelating agent being covalently bonded to said polymer and being chosen from nitrilotriacetic acid and ethylenediaminetetraacetic acid.

23. The process as claimed in claim 14, characterized in that the electroactive polymer is chosen from polypyrrole, polyacetylene, polyazine, poly(p-phenylene), poly(p-phenylene vinylene), polypyrene, polythiophene, polyethylenedioxythiophene, polyfuran, polyselenophene, polypyridazine, polycarbazole and polyaniline.

24. The process as claimed in claim 14, characterized in that the chelating agent is chosen from iminodiacetic acid, nitrilotriacetic acid and ethylenediaminetetraacetic acid.

25. The process as claimed in claim 15, characterized in that the chelating agent is chosen from iminodiacetic acid, nitrilotriacetic acid and ethylenediaminetetraacetic acid.

26. The process as claimed in claim 14, characterized in that the electroactive polymer is a polypyrrole and the chelate is iminodiacetic acid (IDA) or nitrilotriacetic acid (NTA), said chelate being attached via a covalent bond in the 3-position of the pyrrole ring through the agency of a carboxymethyl residue.

27. The process as claimed in claim 15, characterized in that the electroactive polymer is a polypyrrole and the chelate is iminodiacetic acid (IDA) or nitrilotriacetic acid (NTA), said chelate being attached via a covalent bond in the 3-position of the pyrrole ring through the agency of a carboxymethyl residue.

28. The process as claimed in claim 16, characterized in that the electroactive polymer is a polypyrrole and the chelate is iminodiacetic acid (IDA) or nitrilotriacetic acid (NTA), said chelate being attached via a covalent bond in the 3-position of the pyrrole ring through the agency of a carboxymethyl residue.

29. The electroactive probe as claimed in claim 19, characterized in that the electroactive polymer is a polypyrrole and the chelate is nitrilotriacetic acid, said chelate being attached via a covalent bond in the 3-position of the pyrrole ring through the agency of a carboxymethyl residue.

30. An electrode, all or part of the surface of which is coated with a probe as defined in claim 19.

31. An electrode, all or part of the surface of which is coated with a probe as defined in claim 20.
